(19) United States
(12) Patent Application Publication
(10) Pub. No.: US 2025/0231117 A1
(43) Pub. Date: Jul. 17, 2025

(54) SYSTEM AND METHOD OF MEASURING AN ANGLE BETWEEN TWO SURFACES

(71) Applicant: Baker Hughes Holdings LLC, Houston, TX (US)

(72) Inventor: Clark A. Bendall, Skaneateles, NY (US)

(21) Appl. No.: 19/015,157

(22) Filed: Jan. 9, 2025

Related U.S. Application Data
(60) Provisional application No. 63/621,706, filed on Jan. 17, 2024.

(51) Int. Cl. G01N 21/88; G01M 15/14; G01N 21/954; G02B 23/24

(52) U.S. Cl. CPC G01N 21/8851; G01M 15/14; G01N 21/954; G02B 23/2461; G02B 23/2484; G01N 2201/126

(57) ABSTRACT

A method can include receiving data characterizing a two-dimensional image of an asset including a first surface and a second surface and a set of three-dimensional surface points characterizing the asset. Each point in the set of three-dimensional surface points can be associated with a pixel of a plurality of pixels in the two-dimensional image. The method can also include generating a graphical user interface (GUI) including at least one of the two-dimensional image and a three-dimensional point cloud view of the asset. The method can include determining a first plane and a second plane associated with pixels of the two-dimensional image. The method can also include determining an angle between the first plane and the second plane and providing the angle via the GUI. Related systems and apparatuses are also provided.

### CROSS-REFERENCE TO RELATED APPLICATIONS

This application claims the benefit of U.S. Provisional Application Ser. No. 63/621,706, filed on Jan. 17, 2024, which is incorporated herein by reference in its entirety.

### BACKGROUND

The subject matter disclosed herein relates generally to a system and method for measuring angles between surfaces of an object, specifically objects being inspected by video inspection devices, such as video endoscopes or borescopes.

Video inspection devices, such as video endoscopes or borescopes, can be used to inspect objects/assets to identify and analyze anomalies that may have resulted from, e.g., damage, wear, corrosion, improper installation, etc. In many instances, the surface of the object is inaccessible and cannot be viewed without the use of the video inspection device. For example, a video inspection device can be used to inspect the surface of a blade of a turbine engine on an aircraft or power generation unit to identify any anomalies that may have formed on the surface to determine if any repair or further maintenance is required. In order to make that assessment, it is often necessary to obtain highly accurate dimensional measurements of the surface and the anomaly to verify that the anomaly does not exceed or fall outside an operational limit or required specification for that object.

### SUMMARY

In one aspect, a method is provided and in one embodiment, the method can include receiving, by one or more processors, data characterizing a two-dimensional image of at least a portion of an asset including a first surface and a second surface, and a set of three-dimensional surface points characterizing the portion of the asset. Each point in the set of three-dimensional surface points can be associated with a pixel of a plurality of pixels in the two-dimensional image. The method can also include generating, by the one or more processors, a graphical user interface (GUI) comprising at least one of the two-dimensional image and a three-dimensional point cloud view of the asset. The method can further include determining a first plane associated with pixels of the plurality of pixels in the two-dimensional image on the first surface. The method can also include determining a second plane associated with pixels of the plurality of pixels in the two-dimensional image proximal to the second surface. The method can further include determining, by the one or more processors, an angle between the first plane and the second plane and providing the angle between the first plane and the second plane via the GUI.

One or more of the following features can be included in any feasible combination. For example, in one embodiment, the method can also include receiving, by the one or more processors via the GUI from a user, a first selection of the plurality of pixels on the first surface and receiving, by the one or more processors via the GUI from the user, a second selection of the plurality of pixels proximal to the second surface. In another embodiment, the first selection can include placing, by the user, each of a plurality of first points on a pixel of the plurality of pixels on the first surface, and the second selection can include placing an open cursor proximal to a region of interest of the second surface. The open cursor can define a boundary of the plurality of pixels proximal to the second surface. In one embodiment, the second plane can be determined by fitting a plane to the three-dimensional surface points associated with the plurality of pixels proximal to the second surface, defined by the open cursor.

In another embodiment, the data characterizing the two-dimensional image of at least a portion of the asset further can include one or more structured light images of the portion of the asset. The method further include determining, based on the one or more structured light images, the set of three-dimensional surface points characterizing the portion of the asset. In another embodiment, the asset is a blade and the first surface is a blade surface and the second surface is a blade edge. In one embodiment, generating the GUI can include generating a split-screen view that includes the two-dimensional image and the three-dimensional point cloud view of the asset. In another embodiment, the method can include identifying a first set of three-dimensional points within a first predetermined distance from the first plane and a second set of three-dimensional points within a second predetermined distance from the second plane. The method can further include displaying at least one semi-transparent graphical mask element within at least one of the two-dimensional image and the three-dimensional point cloud at pixel locations associated with the first and second sets of three-dimensional points.

In another aspect a borescope system is provided and in one embodiment, can include an image sensor, a display, a memory storing computer-executable instructions and a data processor. The data processor can be communicatively coupled to the image sensor, the display, and the memory, and can be configured to execute the computer-executable instructions stored in the memory, which when executed can cause the data processor to perform operations including receiving data characterizing a two-dimensional image of at least a portion of an asset including a first surface and a second surface, and a set of three-dimensional surface points characterizing the portion of the asset. Each point in the set of three-dimensional surface points can be associated with a pixel of a plurality of pixels in the two-dimensional image. The instructions can further cause the data processor to generate a graphical user interface (GUI) within the display comprising at least one of the two-dimensional image and a three-dimensional point cloud view of the asset. The instructions can further cause the data processor to determine a first plane associated with pixels of the plurality of pixels in the two-dimensional image on the first surface and a second plane associated with pixels of the plurality of pixels in the two-dimensional image proximal to the second surface. The instructions can further cause the data processor to determine an angle between the first plane and the second plane and to provide the angle between the first plane and the second plane via the GUI.

One or more of the following features can be included in any feasible combination. For example, in one embodiment, the data processor can be further configured to receive, via the GUI from a user, a first selection of the plurality of pixels on the first surface and a second selection of the plurality of pixels proximal to the second surface. In another embodiment, the first selection can include placing, by the user, each of a plurality of first points on a pixel of the plurality of pixels on the first surface, and the second selection can include placing an open cursor proximal to a region of interest of the second surface. The open cursor can define a boundary of the plurality of pixels proximal to the second surface. In one embodiment, the second plane can be determined by fitting a plane to the three-dimensional surface points associated with the plurality of pixels proximal to the second surface, defined by the open cursor.

In another embodiment, the data characterizing the two-dimensional image of at least a portion of the asset can further include one or more structured light images of the portion of the asset, and the computer-executable instructions are further configured to cause the data processor to determine, based on the one or more structured light images, the set of three-dimensional surface points characterizing the portion of the asset. In one embodiment, the asset can be a blade and the first surface is a blade surface and the second surface is a blade edge. In another embodiment, determining the angle between the first plane and the second plane can further include determining a first angle of the second plane relative to the first plane. The first angle can be an angle of deflection of the second plane relative to the first plane. In one embodiment, determining the angle between the first plane and the second plane can further include determining a second angle of the second plane relative to the first plane. The second angle can be a supplemental angle of the first angle.

In another embodiment, instructions are further configured to generate the GUI such that the two-dimensional image and the three-dimensional point cloud view of the asset can be displayed in a split-screen view of the GUI. In one embodiment, the borescope system can further include an elongated probe having a flexible insertion tube and a head assembly coupled thereto and including the image sensor. In another embodiment, the borescope system can further include a detachable tip positioned at a distal end of the head assembly. The detachable tip can include at least one of a light source and a waveguide configured to alter a viewing angle of the image sensor and/or the at least one light source.

In another embodiment, the computer-executable instructions can be configured to cause the data processor to identify a first set of three-dimensional points within a first predetermined distance from the first plane and a second set of three-dimensional points within a second predetermined distance from the second plane. The computer-executable instructions can be configured to cause the data processor to display at least one semi-transparent graphical mask element within at least one of the two-dimensional image and the three-dimensional point cloud at pixel locations associated with the first and second sets of three-dimensional points.

### BRIEF DESCRIPTION OF THE DRAWINGS

These and other features will be more readily understood from the following detailed description taken in conjunction with the accompanying drawings, in which:

FIG. 1 is a flow diagram of an exemplary method for measuring an angle between two surfaces as described herein;

FIG. 2A illustrates an exemplary embodiment of a GUI of a video inspection device displaying a two-dimensional image of at least a portion of an asset being inspected;

FIG. 2B illustrates another exemplary embodiment of a GUI of a video inspection device displaying a plurality of viewing settings which can be selected for viewing the two-dimensional image of FIG. 2A;

FIG. 3 illustrates another exemplary embodiment of a GUI of a video inspection device displaying a Surface Angle functionality, as described herein;

FIG. 4 illustrates another exemplary embodiment of a GUI of a video inspection device for determining a first plane associated with pixels on a first portion of the asset being inspected;

FIG. 5 illustrates another exemplary embodiment of a GUI of a video inspection device for determining a second plane associated with pixels on a second portion of the asset being inspected and determining an angle between the second plane and the first plane of FIG. 4;

FIG. 6 illustrates another exemplary embodiment of a GUI of a video inspection device displaying a side view of the full three-dimensional point cloud view of the asset of FIG. 5; and

FIG. 7 is a block diagram of an exemplary video inspection device according to the systems and methods described herein.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Video inspection devices, such as video endoscopes or borescopes, can be used to inspect assets to identify and analyze anomalies that may have resulted from, e.g., damage, wear, corrosion, improper installation, etc. For example, when a jet engine ingests foreign objects (e.g., birds or debris) corners of the blades in the compressor section can be bent or curled, which reduces efficiency. When events like this take place, it can be necessary to perform an inspection of the engine/asset to assess the damage, as some industry inspection standards have maximum tolerable angles of deflection for bent/curled blades that are in use. In this case borescope systems can be deployed within the asset being inspected and used to obtain and display two-dimensional images/videos of surfaces within the asset. These images can be viewed and analyzed by the borescope system to determine a health of the interior of the asset. However, conventional borescope software is only capable of determining an angle between two line segments defined by a user. This type of angle determination is ineffective when it comes to quantifying the angle of deflection of a bent/curled blade, as the bends/curls tend to be quite rounded. Thus, determining an angle between two line segments can provide inaccurate determinations of the angle of deflection, as the bent/curled surfaces cannot be well represented by two straight lines.

The systems and methods described herein provide an effective and efficient way to determine an angle of deflection between two surfaces of an asset or a portion of an asset. The systems and methods described herein make use of 3D surface data acquired by image/video sensors (e.g., of image/video inspection devices) using methods such as structured light image/video acquisition and/or stereoscopic image/video acquisition. Based on the 3D surface data, the systems and methods described herein can generate interactive graphical user interfaces (GUIs) which allow a user to determine a first plane on a first surface of the asset, and a second plane on a second surface of the asset and determine a 3D angle between the two planes.

Accordingly, the systems and methods described herein improve upon traditional approaches of determining angles of deflection using line segments, which can be ineffective for bent/curled portions of assets (e.g., turbine/engine blades), as the bent/curled portions tend to be rounded and hard to characterize using line segments. Rather, the systems and methods described herein make use of 3D surface data, as described above, to determine planes of best fit, and determine angles of deflection between the planes, thereby improving the accuracy of angle of deflection determination between two surfaces of an asset or a portion of an asset by image/video inspection devices.

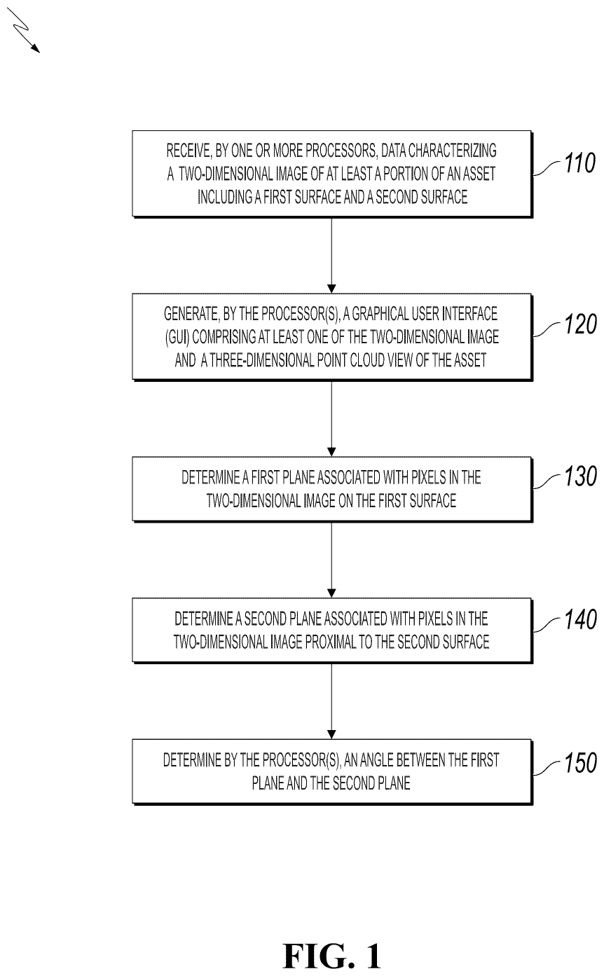

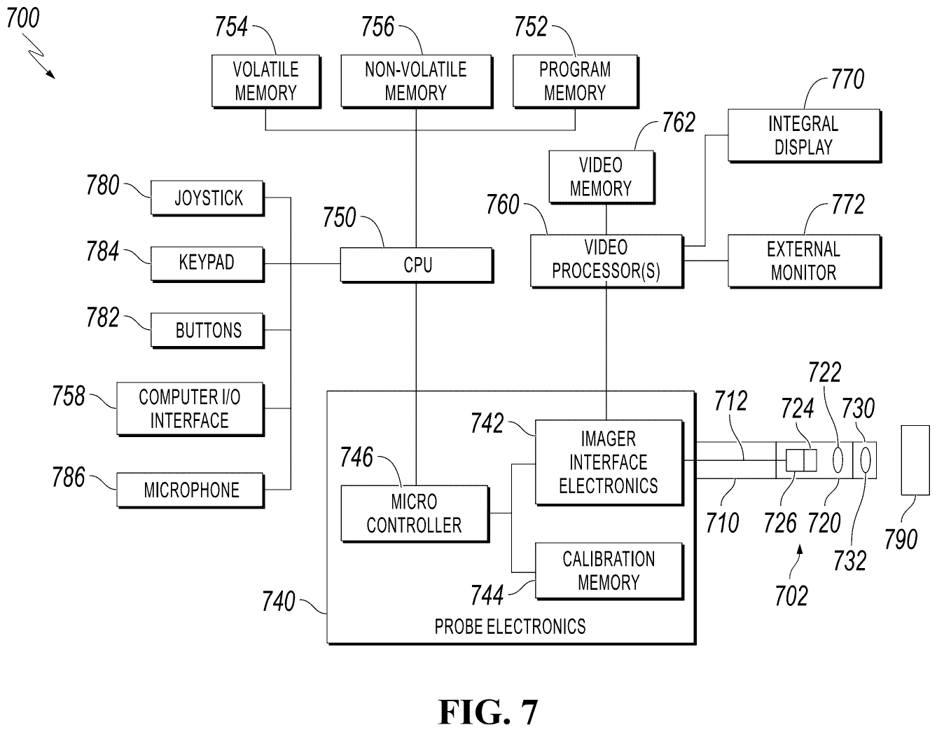

FIG. 1 is a flow diagram of an exemplary method 100 for measuring an angle between two surfaces as described herein. In some aspects, the method 100 can be executed on a borescope device (also described herein as a video inspection device) which can include, but is not limited to, an image sensor, a display, and one or more processors configured to operations. An exemplary borescope device according to the subject matter described herein is provided in greater detail below in reference to FIG. 7. As shown in FIG. 1, the method 100 can include a step 110 of receiving, by the processor(s), data characterizing a two-dimensional image of an object/asset to be inspected. In some aspects, a user can navigate the image sensor of the borescope within the asset while viewing a live video feed on the display as seen from the image sensor. When the user reaches a portion of the asset that they wish to inspect, they can interact with the borescope to capture a two-dimensional image of the portion of the asset to use for the inspection. For example, in some aspects, the asset being inspected can be an engine and the two-dimensional image can include at least a portion of the engine (e.g., a blade) including a first surface (e.g., a blade surface) and a second surface (e.g., a blade edge/corner). In some embodiments, the portion of the engine including the first and second surfaces can be characterized by data that includes a set of three-dimensional surface points, wherein each point in the set of three-dimensional surface points is associated with a pixel of a plurality of pixels in the two-dimensional image. In some embodiments, the set of three-dimensional surface points can be computed from the two-dimensional image data. In some aspects, the data characterizing a two-dimensional image can include one or more structured light images, white light images, stereoscopic images, or the like, of the portion of the blade. The structured light/white light/stereoscopic images can be used by the system to determine 3D surface data of the asset including the set of three-dimensional surface points associated with each pixel of the plurality of pixels in the two-dimensional image(s).

The method 100 can also include a step 120 of generating, by the one or more processors, a graphical user interface (GUI) comprising at least one of the two-dimensional image and a three-dimensional point cloud view of the asset. In some aspects, the GUI can be displayed within the display of the borescope device.

The method 100 can also include a step 130 of determining a first plane associated with pixels of the plurality of pixels in the two-dimensional image on the blade surface. A plane can typically be defined by an equation of the form A*x+B*y+C*z+D=0. The A, B, C, and D terms that define the plane may be determined in a variety of ways. Given three distinct, non-colinear, three-dimensional surface points, the A, B, and C terms for the plane containing those points can be determined as the x, y, and z components respectively of the cross product of any two vectors defined by pairs of the three points. With A, B, and C thus determined, the x, y, and z values of any of the three points can then be used to determine the value of the D term. Alternatively, the A, B, C, and D terms may be determined using least-squares linear regression or other techniques using three or more three-dimensional surface points.

In some embodiments, a plane can be determined from 3 points, e.g., pixel locations, within the two-dimensional image as described above. In some aspects, the determining of the first plane can be done by selecting a plurality of pixels on the blade surface and determining, by the processor, a plane based on the three-dimensional surface points associated with the selected plurality of pixels using, for example, a least squares linear regression. In some aspects the plurality of pixels can be selected by a user by placing, within the GUI, a first plurality of points on the plurality of pixels, as described in greater detail below. In some embodiments, the three-dimensional point cloud view can be generated to include one or more three-dimensional line segments on each of the first plane and the second plane.

The method 100 can also include a step 140 of determining a second plane, associated with pixels of the plurality of pixels in the two-dimensional image proximal to the blade edge. The second plane can be determined similarly to the first plane described in relation to step 140. In some aspects, the determining of the second plane can be done by selecting a plurality of pixels proximal to the blade edge and determining, by the processor, a plane of best fit through the three-dimensional surface points associated with the selected plurality of pixels, as described in greater detail below.

The method 100 can also include a step 150 of determining, by the one or more processors, an angle between the first plane and the second plane. In some aspects, the angle can be provided within the GUI as a first angle and a second angle wherein the first angle is an angle of deflection of the second plane relative to the first plane, and the second angle is a supplementary angle of the first angle (e.g., 180 degrees minus the first angle), as described in greater detail below.

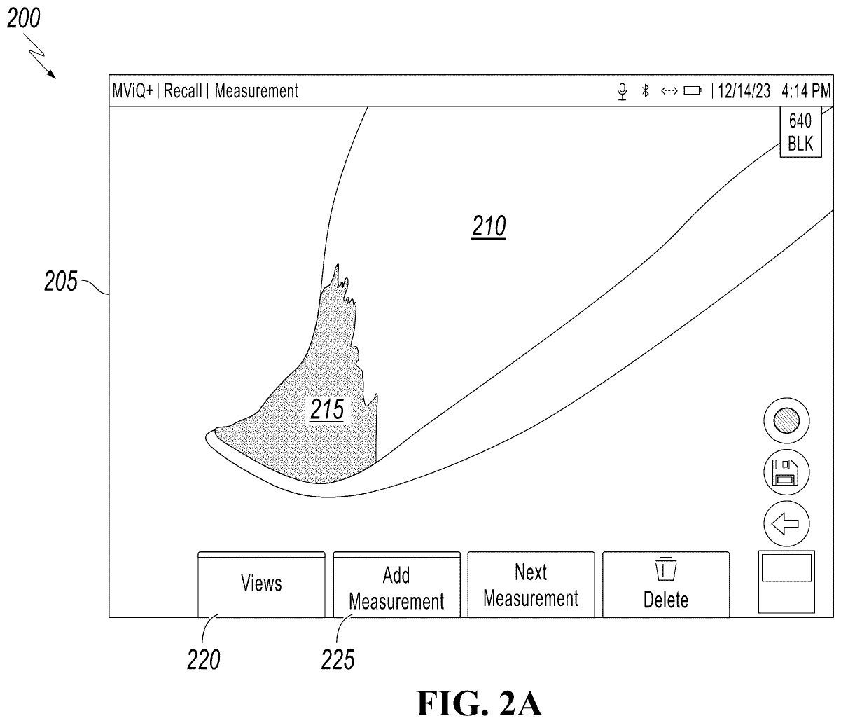

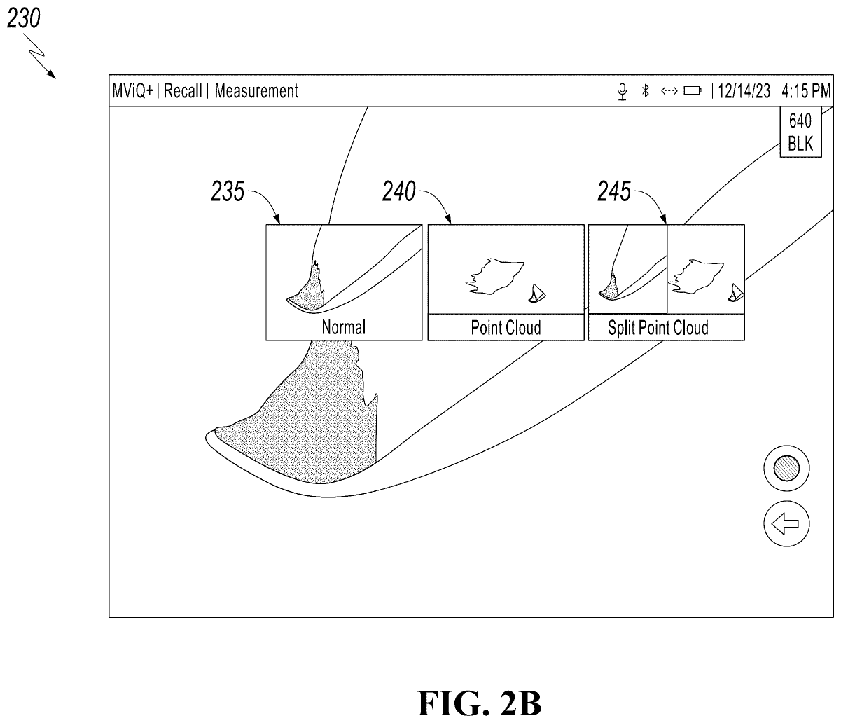

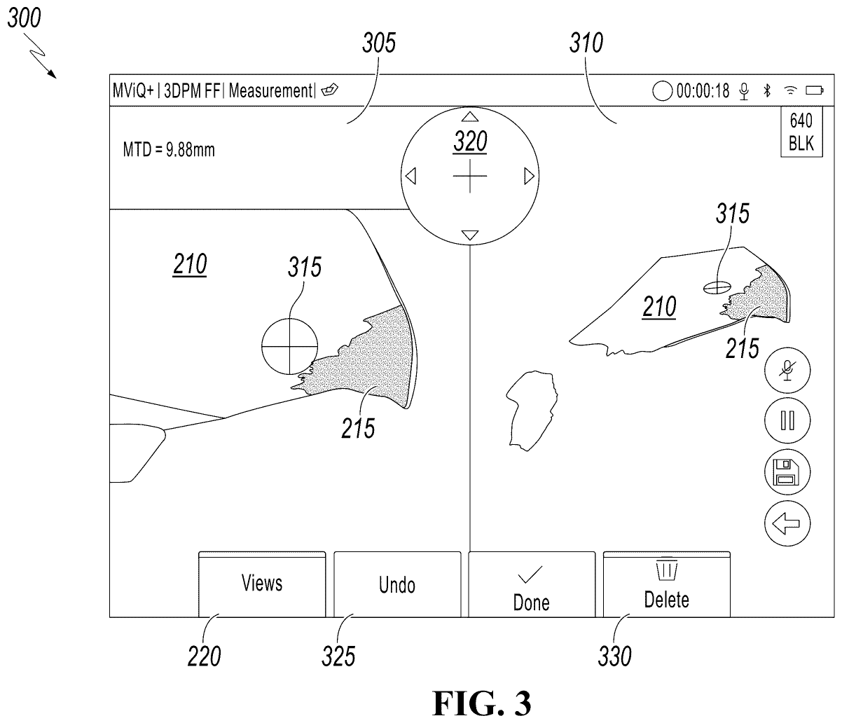

FIG. 2A illustrates an exemplary embodiment of a GUI 200 of a video inspection device (also referred to herein as a borescope device) displaying a two-dimensional image of at least a portion of an asset 205 being inspected. In some cases, as described above, the asset 205 can include a first surface 210 and a second surface 215. For example, the asset being inspected can be an engine and the two-dimensional image can be of a portion of a blade 205 within the engine, however, other portions of other assets are also realized. In this case, as shown in FIG. 2, the GUI 200 can include a two-dimensional image of at least a portion of a blade 205 including a blade surface 210 (first surface) and a blade edge/corner 215 (second surface), captured by the video inspection device. Reference to the portion of a blade 205 including the blade surface 210 and the blade edge 215 of FIG. 2A-2B is made throughout the description of FIGS. 3-8 below. As shown in FIG. 2A, as a result of the engine ingesting foreign objects (e.g., birds or debris), or damage, wear, corrosion, improper installation, etc., the blade edge 215 can be bent or curled, which can reduce efficiency of the engine. In some cases, whether it be an industry standard, or a client standard, there can be maximum tolerable angle of deflection for bent/curled blades that are in use. In this case, when a blade, or other portion of an asset is bent/curled, it can be necessary to perform an inspection to determine the degree of deflection of the blade and determine whether or not the blade needs to be repaired/replaced. Accordingly, the video inspection device described herein can include an elongated probe that is configured to be deployed within the asset to collect image/video data of the asset. In some aspects, the data characterizing the two-dimensional image can include one or more structured light images, white light images, stereoscopic images, or the like. The structured light/white light/stereoscopic images can be used by the system to determine 3D surface data of the asset including a set of three-dimensional surface points characterizing the portion of the asset, wherein each point in the set of three-dimensional surface points is associated with a pixel of a plurality of pixels in the two-dimensional image. The GUI 200 can further include a Views button 220, which will be described in greater detail below, and an Add Measurement button 225. In some aspects, interacting with the Add Measurement button 225 can allow a user to select a measurement functionality from a plurality of functionalities stored within a memory of the video inspection device. In some aspects, one of the plurality of functionalities can include a Surface Angle functionality, as described in greater detail below.

FIG. 2B illustrates another exemplary embodiment of a GUI 230 displaying a plurality of viewing settings which can be selected for viewing the two-dimensional image of the blade 205 of FIG. 2A. In some aspects, the GUI 230 can be generated responsive to a user selecting the Views button 220 of FIG. 2A. As shown in FIG. 2B, the plurality of viewing settings can include, but are not limited to a two-dimensional image view 235, a three-dimensional point cloud view 240 characterizing a three-dimensional rendering of the asset and a split view 245 characterizing a split screen view of both the two-dimensional image view 235 and the three-dimensional point cloud view 240. In some aspects, a user may interact with the GUI 230 to select a view of the plurality of views 235-245 to view the blade 205 during an inspection procedure.

FIG. 3 illustrates an exemplary embodiment of a GUI 300 of a Surface Angle functionality of a video inspection device (also referred to herein as a borescope device) displaying a two-dimensional image of at least a portion of an asset being inspected. As shown in FIG. 3, the GUI 300 can include a split view (e.g., split view 245 of FIG. 2B) of including a two-dimensional image view 305 of the blade 205 and a three-dimensional point cloud view 310 of the blade 205. In some aspects, the GUI 300 can be launched by a user interacting with the Add Measurement button 225 of GUI 200 and selecting the Surface Angle functionality of the plurality of functionalities stored within a memory of the video inspection device. As shown in FIG. 3, the GUI 300 can also include an active cursor 315, as described in greater detail below. The GUI 300 can also include a zoom window 320, which shows a magnified view of a portion of pixels in the vicinity of the active cursor 315. The Surface Angle functionality shown in GUI 300 can further include the Views button 220, an Undo button 325 and a Delete button 330, the functionalities of which are also described in greater detail below.

Further, in some aspects, the user may interact with the GUIs described herein and/or a joystick device or the like of video inspection device to manipulate the two-dimensional image of the blade 205 (e.g., rotate, zoom, move the image sensor to view a different portion thereof).

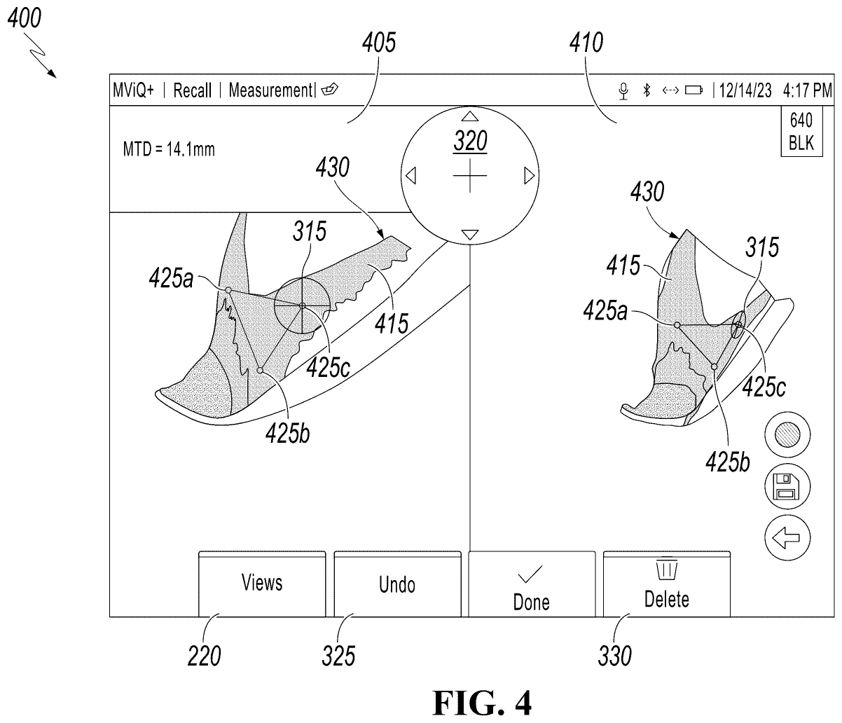

FIG. 4 illustrates another exemplary embodiment of a GUI 400 of the Surface Angle functionality of the video inspection device for determining a first plane 415 associated with pixels on a first portion of the blade 205 of FIG. 2A (e.g., on the blade surface), as described in greater detail below. As shown in FIG. 4, the GUI 400 can include a split view (e.g., split view 245 of FIG. 2B) of including a two-dimensional image view 405 of the blade 205 and a three-dimensional point cloud view 410 of the blade 205. In some aspects, the GUI 400 can be used to determine the first plane 415 on the blade surface 210. For example, in some aspects, the GUI 400 can prompt the user to move the active cursor 315 and place a first plurality of points 425a-425c on the blade surface 210. For example, as described above, in some aspects, the display can be a touch screen display and the user can move the active cursor 315 and place the first plurality of points 425a-425c by touching a first plurality of locations on the blade surface 210 where the user would like a point to be placed. The user can also touch any of the first plurality of points 425a-425c to convert the point back into the active cursor 315 in order to update the selected point's position. In some aspects, the video inspection device can include the joystick device or the like and the user can move the active cursor 315 and place the first plurality of points 425a-425c by interacting with the joystick, and an optionally an Enter button on the borescope (not shown). In some aspects, the GUI 400 can also include the zoom window 320, which shows a magnified view of a portion of pixels in the vicinity of the active cursor 315. The zoom window 320 can provide the user with a more detailed view of the blade surface 210 prior to placing each point 425a-425c. In some aspects, the user can also adjust the position of the active cursor 315 by tapping or clicking one of the arrows in the zoom window 320.

In some aspects the first plurality of points 425a-425c can be associated with pixels of the plurality of pixels on the blade surface 210, and can further be associated with each three-dimensional surface point associated with each pixel. Accordingly, in some aspects, the user can move the active cursor 315 and place the first plurality of points on either of the two-dimensional image view 405 or the three-dimensional point cloud view 410 of the blade 205. Once a point is placed on either of the two-dimensional image view 405 or the three-dimensional point cloud view 410 of the blade 205, a corresponding point can be automatically generated on the other of the two-dimensional image view 405 or the three-dimensional point cloud view 410 at a location corresponding to the same three-dimensional surface point associated with the point placed. For example, as shown in FIG. 4, the user can place each point of the first plurality of points 425a-425c on the two-dimensional image view 405, the system can be configured to automatically generate a copy of the first plurality of points 425a-425c within the three-dimensional point cloud view 410. However, in some aspects, the user can place the points 425a-425c within the three-dimensional point cloud view 410 and the system can be configured to automatically generate the first plurality of points 425a-425c within the two-dimensional image view 405 based on the placement of the points 425a-425c within the three-dimensional point cloud view 410.

The GUI 400 can also include the Views button 220, the Undo button 325 and the Delete button 330. In some aspects, if a user misplaces a point of the first plurality of points 425a-425c, the user can interact with the Undo button 325 to remove the placed point and place a new point. In some aspects, if the user wants to determine a different plane 415, the user can interact with the Delete button 330 to delete all points 425a-425c and start the aforementioned process over from the beginning.

As shown in FIG. 4, responsive to the user placing the first plurality of points 425a-425c, the GUI 400 can be configured to determine the first plane 415 based on the first plurality of points 425a-425c. In some aspects, the GUI 400 can be configured to convey the position of the first plane 415 to the user by displaying a masked region 430 on the blade surface 210, highlighting pixels on the blade surface 210 that are associated with three-dimensional surface points that are less than a threshold distance from the first plane 415, as shown in FIG. 4. In some aspects, the masked region 430 can be aesthetically helpful to the user in order to determine whether the first plane 415 is representative of the surface of the blade 210 proximal to the blade edge 215 to improve the accuracy of the angle of deflection determination described herein.

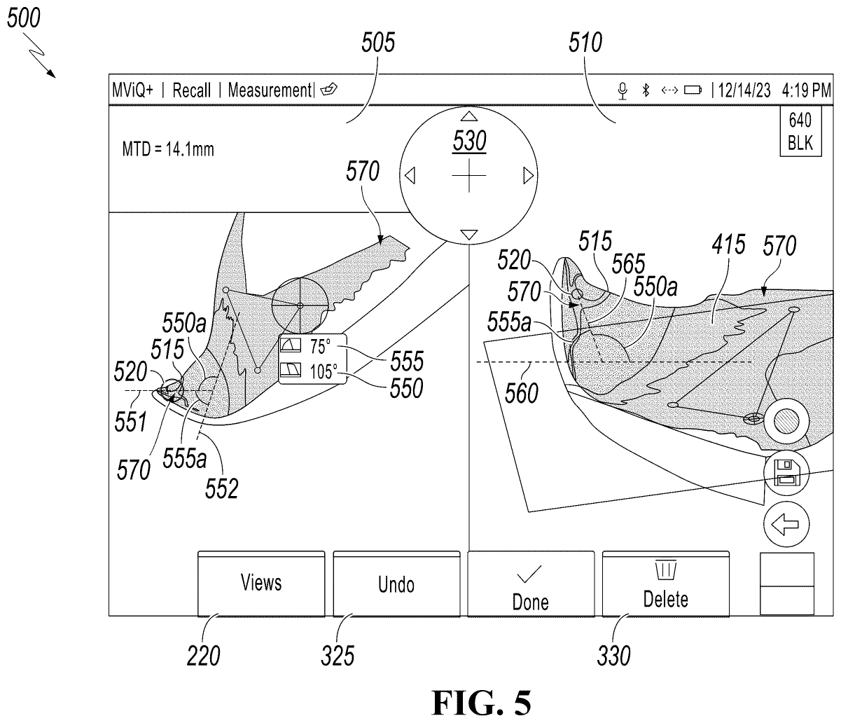

FIG. 5 illustrates another exemplary embodiment of a GUI 500 of the Surface Angle functionality described herein. In some aspects, the GUI 500 can be generated to determine a second plane 515 associated with pixels on a second portion of the blade 205 of FIG. 2 (e.g., near the blade edge), as described in greater detail below. Additionally, in some aspects, the GUI 500 can include components of the GUI 400 of FIG. 4, accordingly, like components will not be described. As shown in FIG. 5, the GUI 500 can include a split view (e.g., split view 245 of FIG. 2B) of including a two-dimensional image view 505 of the blade 205 and a three-dimensional point cloud view 510 of the blade 205. In some aspects, the GUI 500 can be used to determine the second plane 515 proximal to the blade edge 215. Either before or after the user has selected the first plurality of points 425a-425c, the system can be configured to prompt the user to move an open cursor 520 proximal to a region of interest of the blade edge 215. The open cursor 520 can be moved similarly to the active cursor 315 as described above. In some aspects, the open cursor 520 can define a boundary, encapsulating a plurality of pixels proximal to the blade edge 215, wherein each pixel within the boundary is associated with a three-dimensional surface point of the set of three-dimensional surface points. In some aspects, the GUI 500 can also include a zoom window 530, which shows a magnified view of each pixel in the vicinity of the open cursor 520. In some aspects, the zoom window 530 be similar to the zoom window 320 described above for the active cursor 315. Accordingly, the zoom window 530 can allow the user to more easily verify that the open cursor 520 is located at a location that is most characteristic of the bent/curled portion of the blade edge 215 prior to placing the open cursor 520. In some aspects, the user can also adjust the position of the open cursor 520 by tapping or clicking one of the arrows in the zoom window 530.

Additionally, similarly to as described above, the user can place the open cursor 520 on either of the two-dimensional image view 505 or the three-dimensional point cloud view 510 of the blade 205 and a corresponding open cursor 520 can be automatically generated on the other of the two-dimensional image view 505 or the three-dimensional point cloud view 510 at a location corresponding to the same three-dimensional surface point associated with the open cursor 520 placed.

The GUI 500 can also include an Undo button 325, a Delete button 330. In some aspects, if a user misplaces the open cursor 520, the user can interact with the Undo button 325 to remove the placed point and place a new open point 525. In some aspects, if the user wants to start the process from the beginning, the user can interact with the Delete button 330 to delete the open point 525 along with all points 425a-425c and start the aforementioned process over from the beginning.

As shown in FIG. 5, responsive to the user placing the open cursor 520, the system can be configured to determine the second plane 515 by performing a fitting regression on the set of three-dimensional surface points within the boundary of the open cursor 520. Similarly to as described above, the GUI 500 can be configured to convey the position of the second plane 515 to the user by displaying a masked region 570 on the blade edge 215, highlighting pixels on the blade edge 215 that are associated with three-dimensional surface points that are less than a threshold distance from the second plane 515, as shown in FIG. 5. In some aspects, the masked region 570 can be aesthetically helpful to the user in order to determine whether the second plane 515 is representative of the bent/curled portion of the blade edge 215 to improve the accuracy of the angle of deflection determination described herein.

Further, as shown in FIG. 5, once the first plane 415 and the second plane 515 are determined, the system can be configured to determine an angle 550 between the first plane 415 and the second plane 515. In some aspects, the angle 550 can be generated and provided within the two-dimensional image view 505 and/or the three-dimensional point cloud view 510 of the GUI 500 as shown, wherein the angle 550 corresponds to an angle between the blade surface 210 and the bend/curled corner of the blade edge 215. In some aspects, the system can further be configured to generate a supplementary angle 555 within the GUI as shown, wherein the supplementary angle 555 corresponds to angle of deflection of the blade edge from its original position, as discussed in greater detail below. Accordingly, the angle 550 and the supplementary angle 555 can sum to 180 degrees. In some aspects, visualizations of the angle 550 and the supplementary angle 555 can be generated within the two-dimensional image view 505, which can include angle lines 551, 552 and arcs 550a and 555a, respectively can be displayed on the 2D image by projecting lines/arcs defined in 3D space back into 2D space.

Additionally, as shown in the three-dimensional point cloud view 510, responsive to the system determining the angle 550, the GUI 500 can be configured to render a first line 560 parallel to the first plane 415 and a second line 565 on the second plane 515. The first line 560 and the second line 565 can intersect at a vertex of the angle 550 (corresponding to angle 550), wherein the first line 560 and the second line 565 are perpendicular to a line defined by the intersection of the first plane 415 and the second plane 515 (not shown). In some aspects, arcs 550a, 555a can also be rendered between the first line 560 and the second line 565, as described above. In some embodiments, the arcs 550a, 555a can be provided as colored lines or have a similarly visually distinguishing treatment, such as dashed lines, pattern lines, or the like.

Further, as shown in FIG. 5, the system can be configured to identify a first set of three-dimensional surface points within a first predetermined distance of the first plane 415 and a second set of three-dimensional points within a second predetermined distance of the second plane 515. In some embodiments, the first or second predetermined distances can be fixed values, such as 1 mm. In some embodiments, the first or second predetermined distances can a percentage (e.g., 1%) of a three-dimensional z-coordinate of each three-dimensional surface point. In some embodiments, the first and second predetermined distances can be different values. In some embodiments, the first and second predetermined distances be the same value. The system can be configured to display one or more graphical mask elements 570 within the two-dimensional view 505 and/or the three-dimensional point cloud view 510 at pixel locations associated with the first and second sets of three-dimensional surface points. In some embodiments, the graphical mask elements 570 can include semi-transparent masks. In some embodiments, the graphical mask elements can include a color.

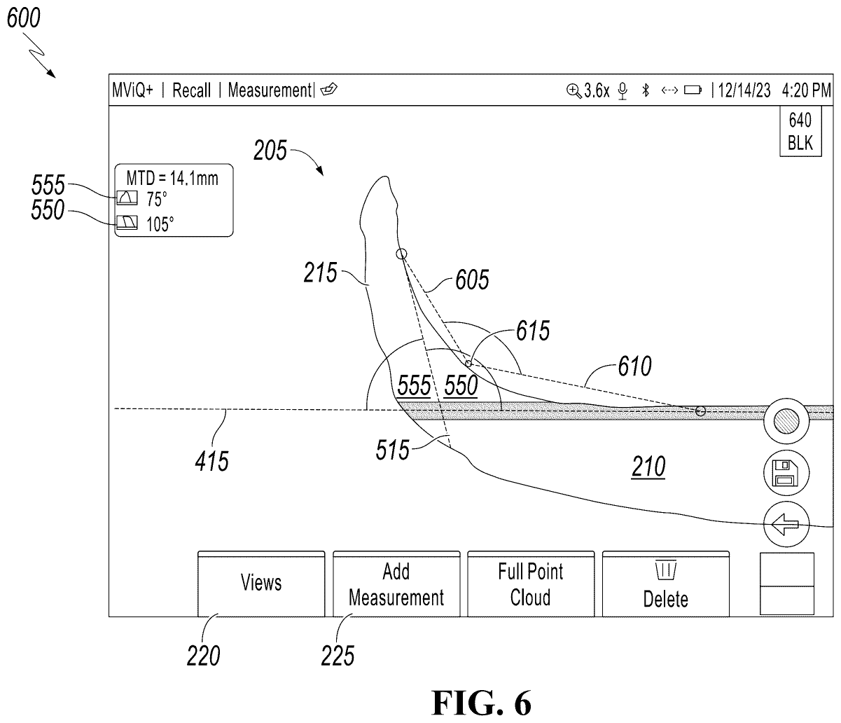

FIG. 6 illustrates a full screen side view 600 (which corresponds to the three-dimensional point cloud view 510 of FIG. 5), displaying a side view of the three-dimensional point cloud of the portion of the blade 205. As discussed above, conventional borescope software is only capable of determining an angle between two line segments defined by a user. This type of angle determination is ineffective when it comes to quantifying the angle of deflection of a bent/curled blade, as the bends/curls tend to be quite rounded. For example, as shown in FIG. 6, under a conventional method, as user may attempt to determine an angle of deflection of the blade edge 215 by placing lines 605 and 610, intersecting at point 615. However, due to the rounded nature of the bent blade edge 215, the intersection point 615 placed under conventional methods on the surface of the blade 210, results in lines 605 and 610 departing from the blade surface leading to an inaccurate determination of the angle of deflection.

Accordingly, as shown in the full screen side view 600, the first plane 415 and the second plane 515 can each be configured to project through the curled/rounded portion of the blade edge 215, to intersect at the vertex of the angle 550. Additionally, the system can further be configured to generate the supplementary angle 555 within the full screen side view 600 as shown, wherein the supplementary angle 555 corresponds to angle of deflection of the blade edge 215 from its original position.

FIG. 7 is a block diagram of an exemplary video inspection device 700 according to the systems and methods described herein. It will be understood that the video inspection device 700 shown in FIG. 7. Is exemplary and that the scope of the invention is not limited to any particular video inspection device 700 or any particular configuration of components within a video inspection device 700.

Video inspection device 700 can include an elongated probe 702 comprising an insertion tube 710 and a head assembly 720 disposed at the distal end of the insertion tube 710. Insertion tube 710 can be a flexible, tubular section through which all interconnects between the head assembly 720 and probe electronics 740 are passed. Head assembly 720 can include probe optics 722 for guiding and focusing light from the viewed object 790 onto an imager 724. The probe optics 722 can comprise, e.g., a lens singlet or a lens having multiple components. The imager 724 can be a solid-state CCD or CMOS image sensor for obtaining an image of the viewed object 790.

A detachable tip or adaptor 730 can be placed on the distal end of the head assembly 720. The detachable tip 730 can include tip viewing optics 732 (e.g., lenses, windows, or apertures) that work in conjunction with the probe optics 722 to guide and focus light from the viewed object 790 onto an imager 724. The detachable tip 730 can also include illumination LEDs (not shown) if the source of light for the video inspection device 700 emanates from the tip 730 or a light passing element (not shown) for passing light from the probe 702 to the viewed object 790. The tip 730 can also provide the ability for side viewing by including a waveguide (e.g., a prism) to turn the camera view and light output to the side. The tip 730 may also provide stereoscopic optics or structured-light projecting elements for use in determining three-dimensional data of the viewed surface. The elements that can be included in the tip 730 can also be included in the probe 702 itself.

The imager 724 can include a plurality of pixels formed in a plurality of rows and columns and can generate image signals in the form of analog voltages representative of light incident on each pixel of the imager 724. The image signals can be propagated through imager hybrid 726, which provides electronics for signal buffering and conditioning, to an imager harness 712, which provides wire for control and video signals between the imager hybrid 726 and the imager interlace electronics 742. The imager interface electronics 742 can include power supplies, a timing generator for generating imager clock signals, an analog front end for digitizing the imager video output signal, and a digital signal processor for processing the digitized imager video data into a more useful video format.

The imager interface electronics 742 are part of the probe electronics 740, which provide a collection of functions for operating the video inspection device. The probe electronics 740 can also include a calibration memory 744, which stores the calibration data for the probe 702 and/or tip 730. A microcontroller 746 can also be included in the probe electronics 740 for communicating with the imager interface electronics 742 to determine and set gain and exposure settings, storing and reading calibration data from the calibration memory 744, controlling the light delivered to the viewed object 790, and communicating with a central processor unit (CPU) 750 of the video inspection device 700.

In addition to communicating with the microcontroller 746, the imager interface electronics 742 can also communicate with one or more video processors 760. The video processor 760 can receive a video signal from the imager interface electronics 742 and output signals to various monitors 770, 772, including an integral display 770 or an external monitor 772. The integral display 770 can be an LCD screen built into the video inspection device 700 for displaying various images or data (e.g., the image of the viewed object 790, menus, cursors, measurement results) to an inspector. The external monitor 772 can be a video monitor or computer-type monitor connected to the video inspection device 700 for displaying various images or data.

The video processor 760 can provide/receive commands, status information, streaming video, still video images, and graphical overlays to/from the CPU 750 and may be comprised of FPGAs, DSPs, or other processing elements which provide functions such as image capture, image enhancement, graphical overlay merging, distortion correction, frame averaging, scaling, digital zooming, over laying, merging, flipping, motion detection, and video format conversion and compression.

The CPU 750 can be used to manage the user interface by receiving input via a joystick 780, buttons 782, keypad 784, and/or microphone 786, in addition to providing a host of other functions, including image, video, and audio storage and recall functions, system control, and measurement processing. The joystick 780 can be manipulated by the user to perform such operations as menu selection, cursor movement, slider adjustment, and articulation control of the probe 702, and may include a push button function. The buttons 782 and/or keypad 784 also can be used for menu selection and providing user commands to the CPU 750 (e.g., freezing or saving a still image). The microphone 786 can be used by the inspector to provide voice instructions to freeze or save a still image.

The video processor 760 can also communicate with video memory 762, which is used by the video processor 760 for frame buffering and temporary holding of data during processing. The CPU 750 can also communicate with CPU program memory 752 for storage of programs executed by the CPU 750. In addition, the CPU 750 can be in communication with volatile memory 754 (e.g., RAM), and non-volatile memory 756 (e.g., flash memory device, a hard drive, a DVD, or an EPROM memory device). The non-volatile memory 756 is the primary storage for streaming video and still images.

The CPU 750 can also be in communication with a computer I/O interface 758, which provides various interfaces to peripheral devices and networks, such as USB, Firewire, Ethernet, audio I/O, and wireless transceivers. This computer I/O interface 758 can be used to save, recall, transmit, and/or receive still images, streaming video, or audio. For example, a USB “thumb drive” or CompactFlash memory card can be plugged into computer I/O interface 758. In addition, the video inspection device 700 can be configured to send frames of image data or streaming video data to an external computer or server. The video inspection device 700 can incorporate a TCP/IP communication protocol suite and can be incorporated in a wide area network including a plurality of local and remote computers, each of the computers also incorporating a TCP/IP communication protocol suite. With incorporation of TCP/IP protocol suite, the video inspection device 700 incorporates several transport layer protocols including TCP and UDP and several different layer protocols including HTTP and FTP.

It will be understood that, while certain components have been shown as a single component (e.g., CPU 750) in FIG. 7, multiple separate components can be used to perform the functions of the CPU 750.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a touch-screen display, a cathode ray tube (CRT) or liquid crystal display (LCD) monitor, for receiving inputs and for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

1. A method comprising:
receiving, by one or more processors, data characterizing a two-dimensional image of at least a portion of an asset including a first surface and a second surface, and a set of three-dimensional surface points characterizing the portion of the asset, wherein each point in the set of three-dimensional surface points is associated with a pixel of a plurality of pixels in the two-dimensional image;
generating, by the one or more processors, a graphical user interface (GUI) comprising at least one of the two-dimensional image and a three-dimensional point cloud view of the asset;
determining a first plane associated with pixels of the plurality of pixels in the two-dimensional image on the first surface;
determining a second plane associated with pixels of the plurality of pixels in the two-dimensional image proximal to the second surface;
determining, by the one or more processors, an angle between the first plane and the second plane; and
providing the angle between the first plane and the second plane via the GUI.

2. The method of claim 1, further comprising:
receiving, by the one or more processors via the GUI from a user, a first selection of the plurality of pixels on the first surface; and
receiving, by the one or more processors via the GUI from the user, a second selection of the plurality of pixels proximal to the second surface.

3. The method of claim 2, wherein the first selection comprises placing, by the user, each of a plurality of first points on a pixel of the plurality of pixels on the first surface, and the second selection comprises placing an open cursor proximal to a region of interest of the second surface, wherein the open cursor defines a boundary of the plurality of pixels proximal to the second surface.

4. The method of claim 3, wherein the second plane is determined by fitting a plane to the three-dimensional surface points associated with the plurality of pixels proximal to the second surface, defined by the open cursor.

5. The method of claim 1, wherein the data characterizing the two-dimensional image of at least a portion of the asset further comprises one or more structured light images of the portion of the asset, the method further comprising:
determining, based on the one or more structured light images, the set of three-dimensional surface points characterizing the portion of the asset.

6. The method of claim 1, wherein the asset is a blade and the first surface is a blade surface and the second surface is a blade edge.

7. The method of claim 1, wherein generating the GUI further comprises generating a split-screen view that includes the two-dimensional image and the three-dimensional point cloud view of the asset.

8. The method of claim 1, further comprising:
identifying a first set of three-dimensional points within a first predetermined distance from the first plane and a second set of three-dimensional points within a second predetermined distance from the second plane; and
displaying at least one semi-transparent graphical mask element within at least one of the two-dimensional image and the three-dimensional point cloud at pixel locations associated with the first and second sets of three-dimensional points.

9. A borescope system comprising:
an image sensor;
a display;
a memory storing computer-executable instructions; and
a data processor communicatively coupled to the image sensor, the display, and the memory, the data processor configured to execute the computer-executable instructions stored in the memory, which when executed cause the data processor to perform operations including
receiving data characterizing a two-dimensional image of at least a portion of an asset including a first surface and a second surface, and a set of three-dimensional surface points characterizing the portion of the asset, wherein each point in the set of three-dimensional surface points is associated with a pixel of a plurality of pixels in the two-dimensional image;
generating a graphical user interface (GUI) within the display comprising at least one of the two-dimensional image and a three-dimensional point cloud view of the asset;
determining a first plane associated with pixels of the plurality of pixels in the two-dimensional image on the first surface;
determining a second plane associated with pixels of the plurality of pixels in the two-dimensional image proximal to the second surface;
determining an angle between the first plane and the second plane; and
providing the angle between the first plane and the second plane via the GUI.

10. The borescope system of claim 9, wherein the data processor is further configured to:
receive, via the GUI from a user, a first selection of the plurality of pixels on the first surface and a second selection of the plurality of pixels proximal to the second surface.

11. The borescope system of claim 10, wherein the first selection comprises placing, by the user, each of a plurality of first points on a pixel of the plurality of pixels on the first surface, and the second selection comprises placing an open cursor proximal to a region of interest of the second surface, wherein the open cursor defines a boundary of the plurality of pixels proximal to the second surface.

12. The borescope system of claim 11, wherein the second plane is determined by fitting a plane to the three-dimensional surface points associated with the plurality of pixels proximal to the second surface, defined by the open cursor.

13. The borescope system of claim 9, wherein the data characterizing the two-dimensional image of at least a portion of the asset further comprises one or more structured light images of the portion of the asset, and the computer-executable instructions are further configured to cause the data processor to:
determine, based on the one or more structured light images, the set of three-dimensional surface points characterizing the portion of the asset.

14. The borescope system of claim 9, wherein the asset is a blade and the first surface is a blade surface and the second surface is a blade edge.

15. The borescope system of claim 9, wherein determining the angle between the first plane and the second plane further comprises determining a first angle of the second plane relative to the first plane, wherein the first angle is an angle of deflection of the second plane relative to the first plane.

16. The borescope system of claim 15, wherein determining the angle between the first plane and the second plane further comprises determining a second angle of the second plane relative to the first plane, wherein the second angle is a supplemental angle of the first angle.

17. The borescope system of claim 9, wherein instructions are further configured to generate the GUI such that the two-dimensional image and the three-dimensional point cloud view of the asset are displayed in a split-screen view of the GUI.

18. The borescope system of claim 9, further comprising an elongated probe having a flexible insertion tube and a head assembly coupled thereto and including the image sensor.

19. The borescope system of claim 18, further comprising a detachable tip positioned at a distal end of the head assembly, the detachable tip comprising at least one of a light source and a waveguide configured to alter a viewing angle of the image sensor and/or the at least one light source.

20. The borescope system of claim 9, wherein the computer-executable instructions are further configured to cause the data processor to:
identify a first set of three-dimensional points within a first predetermined distance from the first plane and a second set of three-dimensional points within a second predetermined distance from the second plane; and
display at least one semi-transparent graphical mask element within at least one of the two-dimensional image and the three-dimensional point cloud at pixel locations associated with the first and second sets of three-dimensional points.
